(19) United States
(12) Patent Application Publication
(10) Pub. No.: US 2009/0327913 A1
(43) Pub. Date: Dec. 31, 2009

(54) USING WEB REVISITATION PATTERNS TO SUPPORT WEB INTERACTION

(75) Inventors: Eytan Adar, Seattle, WA (US); Jaime B. Teevan, Bellevue, WA (US); Susan T. Dumais, Kirkland, WA (US); Daniel J. Liebling, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,946

(22) Filed: Jun. 27, 2008

(51) Int. Cl. G06F 3/00

(52) U.S. Cl. 715/745

(57) ABSTRACT

Supporting web interaction using web revisitation patterns is enabled by described methods and devices. In an example embodiment, a method involves collecting, analyzing, and utilizing. Revisitation data is collected. The revisitation data includes two or more visit times for visits to a web page by one or more users. The revisitation data is analyzed to produce at least one revisitation characterization that reflects a revisitation pattern for the web page. The at least one revisitation characterization is utilized to support web interaction.

### BACKGROUND

The internet offers a wealth of information that is typically divided into web pages. A web page is a unit of information that is accessible via the internet. Each web page may be available in any of a number of different formats. Example formats include HyperText Markup Language (HTML), Portable Document Format (PDF), and so forth. Each web page may include or otherwise provide access to other types of information, such as audio, video, or interactive content.

Web pages include information covering news, hobbies, philosophy, technical matters, entertainment, travel, world cultures, and many other topics. The extent of the information available via the internet provides an opportunity to access many different topics. In fact, the number of web pages and the amount of information that are available over the internet is increasing daily. Unfortunately, the size, scope, and dynamics of the internet can make it difficult to locate desired information among the many multitudes of web pages.

### SUMMARY

Supporting web interaction using web revisitation patterns is enabled by described methods and devices. In an example embodiment, a method involves collecting, analyzing, and utilizing. Revisitation data is collected. The revisitation data includes two or more visit times for visits to a web page by one or more users. The revisitation data is analyzed to produce at least one revisitation characterization that reflects a revisitation pattern for the web page. The at least one revisitation characterization is utilized to support web interaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other systems, methods, devices, media, apparatuses, arrangements, and other example embodiments are described herein.

### BRIEF DESCRIPTION OF THE DRAWINGS

The same numbers are used throughout the drawings to reference like and/or corresponding aspects, features, and components.

FIG. 1 is a block diagram that includes examples of web software and that illustrates web page revisitation.

FIG. 2 is a block diagram that illustrates an example operation for web software that involves measured revisitation data and that produces one or more revisitation characterizations.

FIG. 3A is a flow diagram that illustrates an example of a general method for supporting web interaction using web revisitation patterns.

FIG. 3B is an example of web software that is capable of implementing a general method for supporting web interaction using web revisitation patterns.

FIG. 4A depicts a pair of graphs showing inter-visit times for constructing an example revisitation curve.

FIG. 4B depicts four example graph pairs for constructing four different revisitation curves.

FIG. 4C is a flow diagram that illustrates an example of a method for constructing a revisitation curve.

FIG. 4D depicts four example revisitation curves that reflect four revisitation curve group categories.

FIG. 4E is a block diagram of an example approach to assigning a revisitation curve group category to measured revisitation data.

FIG. 5A is a block diagram illustrating an example of how a web browser can support web interaction by using web revisitation patterns with respect to a browsing history.

FIG. 5B is a block diagram illustrating an example of how a web browser can support web interaction by using web revisitation patterns with respect to web page prominence.

FIG. 5C is a block diagram illustrating an example of how a web browser can support web interaction by using web revisitation patterns with respect to web page preloading.

FIG. 6A is a flow diagram that illustrates example general methods for a search engine to support web interaction by using web revisitation patterns.

FIG. 6B is a block diagram that illustrates an example of an operation for a search engine to support web interaction by using web revisitation patterns.

FIG. 6C is a block diagram that illustrates an example of a search engine supporting web interaction by using web revisitation patterns with regard to presenting search results.

FIG. 6D is a flow diagram that illustrates an example of a method for a search engine to support web interaction by using web revisitation patterns with regard to scheduling web re-crawling.

FIG. 7 is a block diagram that illustrates examples for a web site to support web interaction using web revisitation patterns.

FIG. 8 is a block diagram of an example device that may be used to implement embodiments for supporting web interaction using web revisitation patterns.

### DETAILED DESCRIPTION

### 1: Introduction to Web Revisitation Patterns

As noted above, the size and scope of the internet can make it difficult to locate desired information among the many multitudes of web pages. As one way to address this difficulty, internet search engines may be used to locate web pages with desirable information. A word query is input to a search engine to perform a search. The search engine returns a listing of results that correspond to web pages. The returned web page results are considered relevant in some way and to some degree to the word query.

Often, a user may wish to revisit a web page after some time has passed since a previous visit. Using bookmarks or favorites lists, following web links, selecting an auto-complete option, and directly typing a web page's URL into a web browser are common mechanisms for revisiting web content. Search engines are another popular and important mechanism for revisiting web pages. Unfortunately, a traditional search engine's effectiveness at re-finding the previously-visited web page can be adversely impacted by a number of factors. For example, search results for the same word query can vary over time because the number of web pages that are available over the internet is constantly increasing. Additionally, a given web page may be altered over time with updates or with additional information. Any of these or other factors can make re-finding information particularly difficult, even when using a traditional search engine.

Although everybody revisits web pages, their reasons for doing so can differ depending on the particular web page, their topic of interest, and their intent. To better understand how to characterize the way(s) people revisit web content, web interaction logs of hundreds of thousands of users have been analyzed. This analysis has been supplemented by a survey intended to identify the intent behind the observed revisitations. The analysis has revealed four revisitation group categories, each with a different set of behavioral, content, and structural characteristics.

Generally, web revisitation patterns can be used to support web interaction. As is described further herein below, web revisitation patterns can enable web browsers to predict users' destinations; can enable search engines to better support fast, fresh, and efficient finding and re-finding; and can enable web sites to provide improved navigation. Additional example general and specific embodiments are described below.

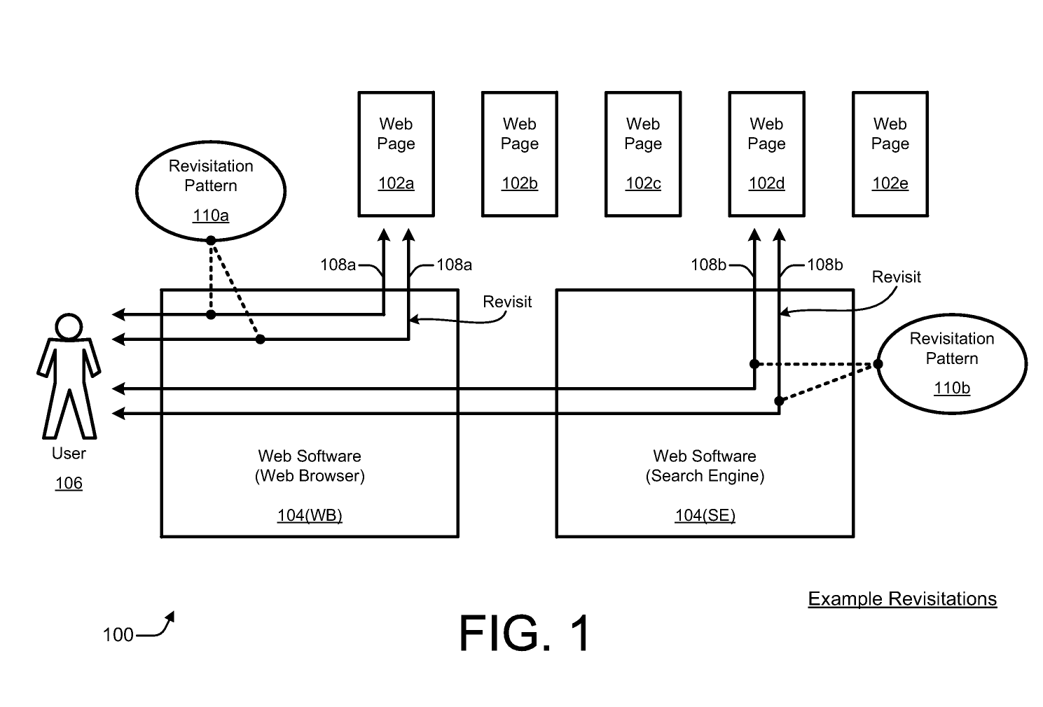

FIG. 1 is a block diagram 100 that includes examples of web software 104 and that illustrates web page visitations 108. As illustrated, block diagram 100 includes multiple web pages 102, web software 104, a user 106, page visitations 108, and revisitation patterns 110. Five web pages 102a, 102b, 102c, 102d, and 102e are shown, but fewer or many more web pages may be involved with web revisitation.

In an example embodiment, user 106 employs web software 104 to visit and revisit web pages 102a and 102d. Two types of web software 104 are explicitly shown: a web browser 104(WB) and a search engine 104(SE). Web browser 104(WB) may be, for example, any program that interacts with a web page, such as a traditional browser, a news reader, a combination thereof, and so forth. However, web software 104 may be of a different type, such as a web server hosting a web site, a web crawler, combinations thereof, and so forth. It should be noted that a web crawler may be included as part of a search engine.

As illustrated with respect to web page 102a, user 106 visits 108a web page 102a using web browser web software 104(WB). User 106 subsequently visits 108a web page 102a again using web browser web software 104(WB). Second and subsequent visits 108 may be considered revisits as indicated in block diagram 100. There may be a single revisitation 108a or many such revisits. As represented by revisitation pattern 110a, this set of revisits forms a pattern. As described further herein, web browser web software 104(WB) may support web interaction (e.g., with web page 102a) using web revisitation pattern 110a.

As illustrated with respect to web page 102d, user 106 visits 108b web page 102d using web browser web software 104(WB) and search engine web software 104(SE). User 106 subsequently visits 108b web page 102d again using web browser web software 104(WB) and search engine web software 104(SE). There may be a single revisitation 108b or many such revisits. As represented by revisitation pattern 110b, this set of revisits forms a pattern. As described further herein, web browser web software 104(WB) and/or search engine web software 104(SE) may support web interaction (e.g., with web page 102d) using web revisitation pattern 110b.

Web page revisitation may be for any of many possible purposes. Example user purposes include, but are not limited to, consuming information, interacting with information, modifying information, manipulating information, some combination thereof, and so forth. These kinds of revisitations to web pages are common, but an individual user's underlying reasons for returning to different web pages can be diverse and the resulting revisitation pattern can be similarly diverse. For example, a person may revisit a shopping site's homepage every couple of weeks to check for sales. That same person may also revisit the site's listing of fantasy books many times in just a few minutes while trying to find a new book. Characterizing these web revisitation patterns can enable web software to better support web interaction.

### 2: Example General Embodiments for Using Web Revisitation Patterns

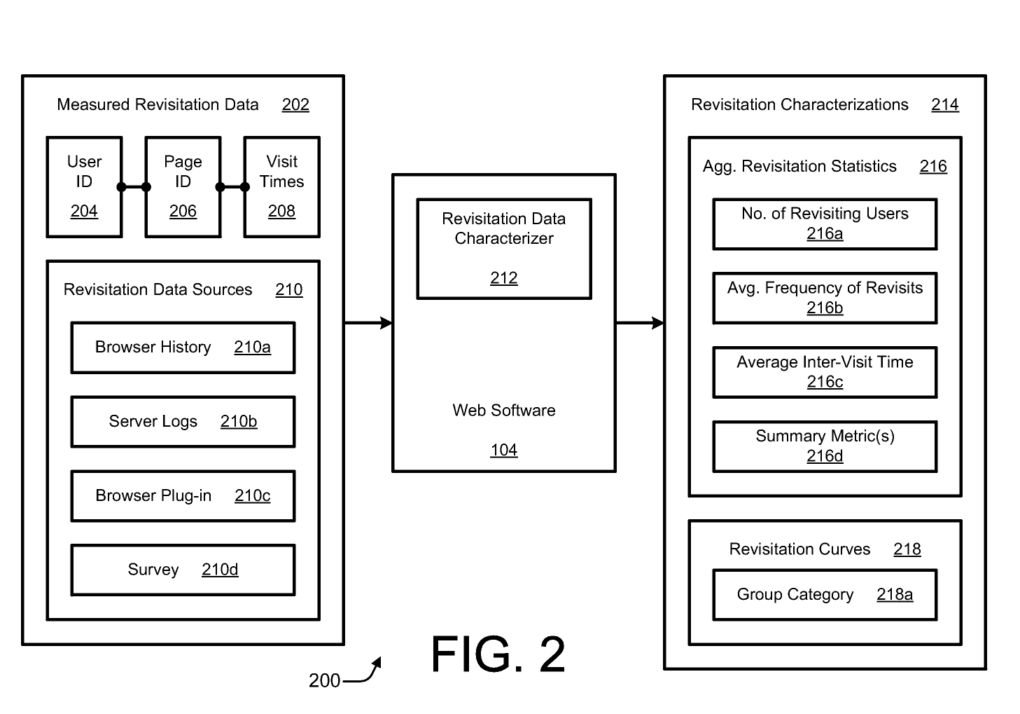

FIG. 2 is a block diagram that illustrates an example operation 200 for web software 104 that involves measured revisitation data 202 and that produces one or more revisitation characterizations 214. As illustrated, measured revisitation data 202 includes data directed toward user identification 204, page identification 206, and visitation times 208. This data may originate from any of many possible revisitation data sources 210. Web software 104 includes a revisitation data characterizer 212. Revisitation characterizations 214 include aggregate revisitation statistics 216 and/or revisitation curves 218.

In an example embodiment, operation 200 entails analyzing measured revisitation data 202 by revisitation data characterizer 212 to produce at least one revisitation characterization 214. Each user identification 204 identifies a user 106 (of FIG. 1) or at least a machine being used by one or more users 106. It may be linked to other identifying information or may be anonymized. Each page identification 206 identifies a web page 102; it may be, for instance, a Uniform Resource Locator (URL). Visit times 208 are a set of timestamps indicating when a corresponding user has visited a corresponding web page.

Measured revisitation data 202 may be collected from any one or more of revisitation data sources 210. Such revisitation data sources 210 include, by way of example but not limitation, the following data or data sources: a browser history 210a, a server log 210b, a browser plug-in 210c (e.g., a toolbar), a survey 210d, some combination thereof, and so forth. The revisitation data that is collected may pertain to a particular individual on a local scale, or it may be aggregated across multiple individuals on a global scale. Measured revisitation data 202 may also be collected (e.g., obtained, retrieved, etc.) from third parties that posses such revisitation data.

Browser history 210a may be acquired from the web browser of one user or multiple users. Server logs 210b may be, for example, the server log or logs of a web server, a proxy server, and so forth. Logs can also be from a search engine. Browser plug-in 210c may be tightly integrated with or loosely coupled to a web browser. Browser plug-in 210c may have other potential uses, too, such as facilitating searches, email retrieval, and so forth. Browser plug-in 210c acquires data on browsing revisits and may forward them to a server for incorporation into a server log 210b. Surveys 210d are implemented at least partially manually. However, responses to surveys can provide insight into the actual intent of a user when revisiting a web page.

Examples of different types of data that may be collected for analysis and examples of different collection methods are provided below in Table 1.

TABLE 1
Summary of data that may be analyzed.

| | | |
|---|---|---|
| Type | Examples | Collection Method |

Usage information

| | | |
|---|---|---|
| Bin | Unique visitors | Log analysis |
| | Time between visits | |
| | Visits per visitor | |
| Patterns | Revisitation curve | Log analysis, clustering |
| Session | Previous URL | Log analysis of URLs |
| | Accessed via search | visited prior to page |

Self-reported intent

| | | |
|---|---|---|
| Survey | Revisitation reason | Survey, monitoring |

Web page content

| | | |
|---|---|---|
| URL | Length | Analysis of URL text |
| | Domain | |
| | Text substrings | |
| Content | Terms | Analysis of content |
| | Link structure | |
| | ODP Category | SVM classifier |
| | Genre | Content classifier |
| Change | Count | Regular crawl |
| Structure | Outlinks | HTML parsing |

Any of the information in Table 1 above may be included as part of measured revisitation data 202 and used by revisitation data characterizer 212 to produce revisitation characterizations 214 for individuals and/or groups of users.

Revisitation characterizations 214 include aggregate revisitation statistics 216 and revisitation curves 218. Aggregate revisitation statistics 216 may include, by way of example, any of the following statistics with regard to a given web page: number of revisiting users 216a, average frequency of revisits 216b, average inter-visit time 216c, summary metric(s) 216d, combinations thereof, and so forth. The aggregated revisitation statistics of aggregate revisitation statistics 216 are aggregated over time for individuals to produce individualized local aggregate revisitation statistics and/or are aggregated over time across multiple users to produce global group aggregate revisitation statistics that are averaged over the multiple users.

The average revisitation frequency 216b represents how many revisits, on average, each user makes to a given web page over a predetermined interval. Average inter-visit time 216c represents the average time between any two consecutive visits by each user to a given web page. Summary metric(s) 216d represent any one or more of multiple standard statistical metrics for summarizing data, such as the mean, the median, the maximum and/or minimum, and so forth.

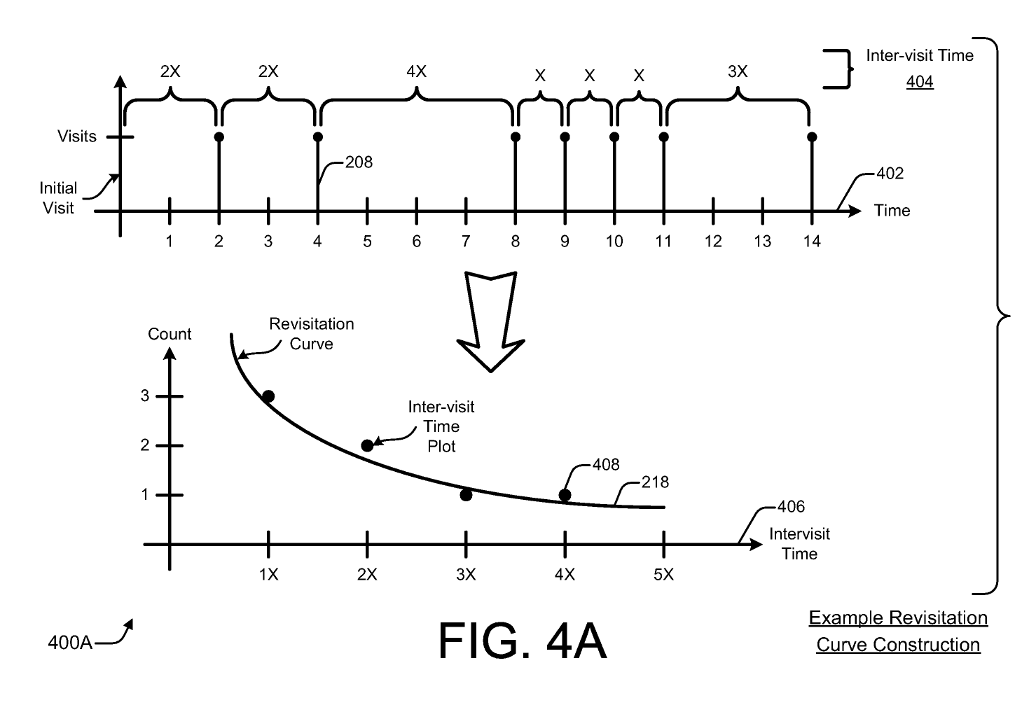

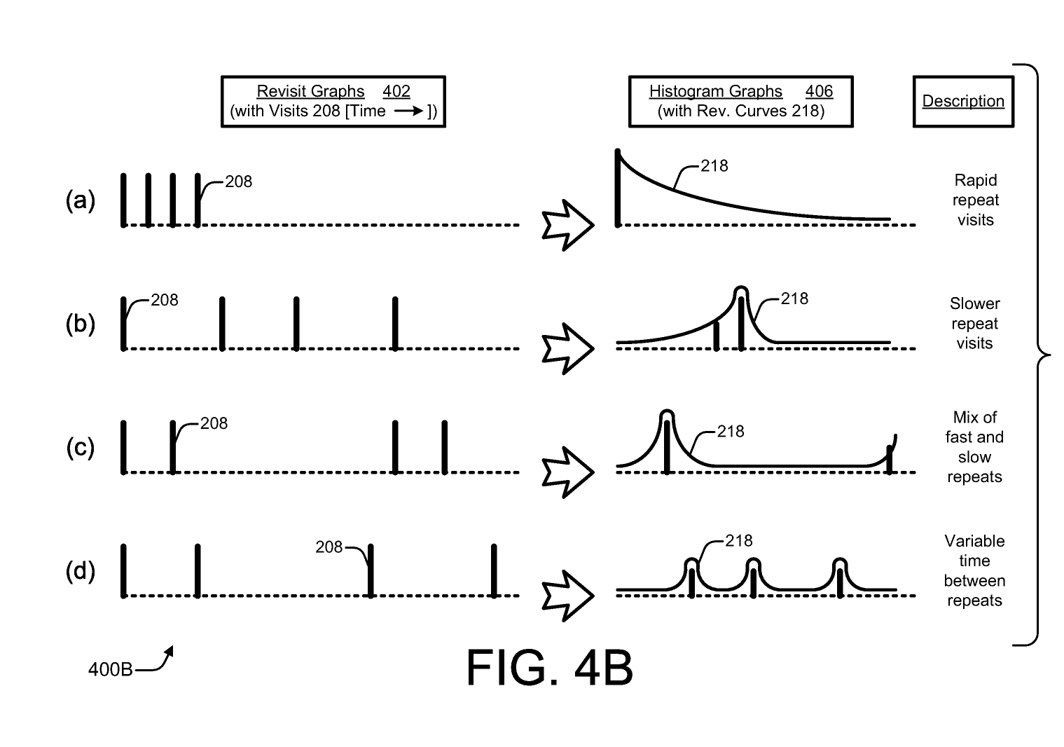

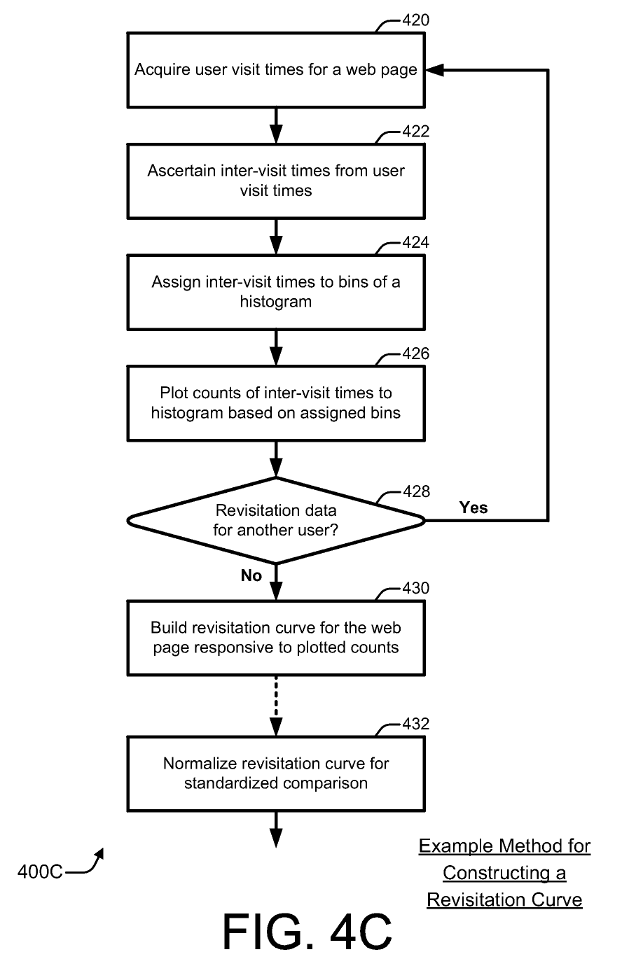

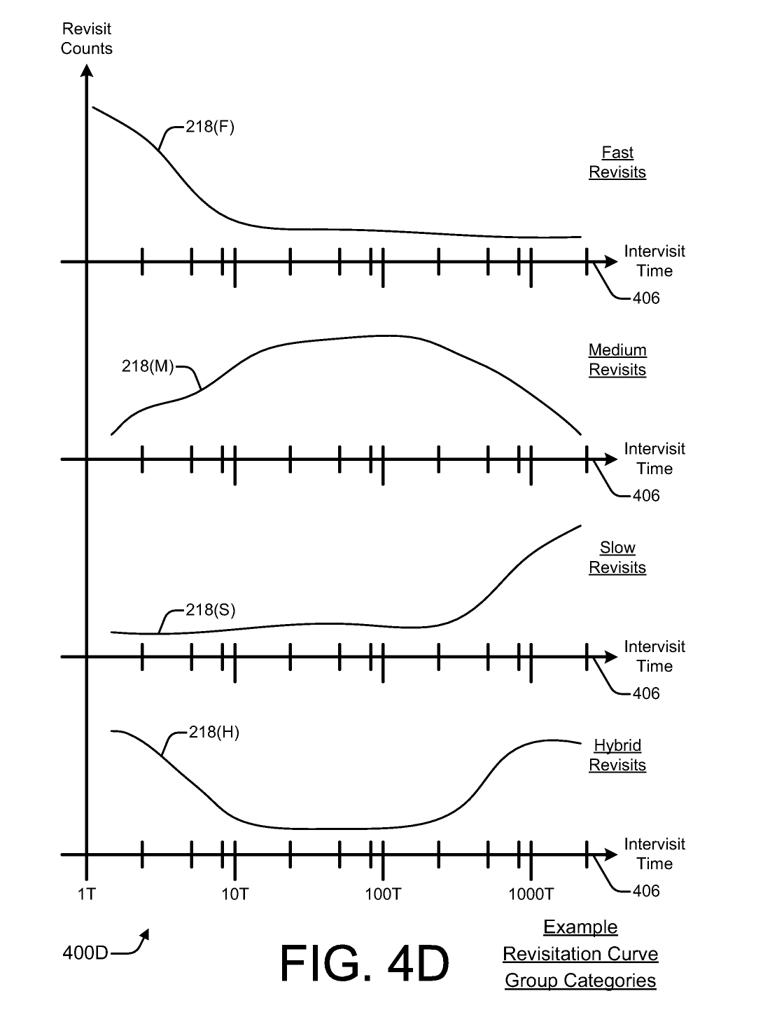

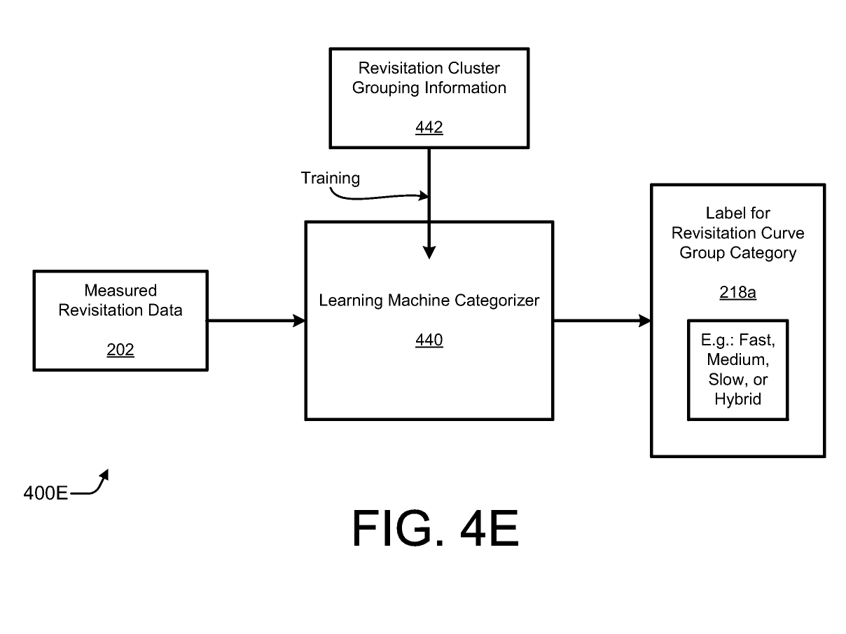

For certain example embodiments, each revisitation curve 218 reflects the revisitation pattern of a given web page in a graphical or other mathematical form that is derived from a timestamp series of interactions with the given web page to represent how users revisit the web page. The revisitation curve can be representative of how one user revisits a given web page or how multiple users on average revisit the given web page. For comparison purposes, a revisitation curve 218 may be normalized. In an example implementation, revisitation curves 218 may be organized by group category 218a or by other curve characteristics. Implementations relating to revisitation curves 218 are described further herein below with particular reference to FIGS. 4A-4E.

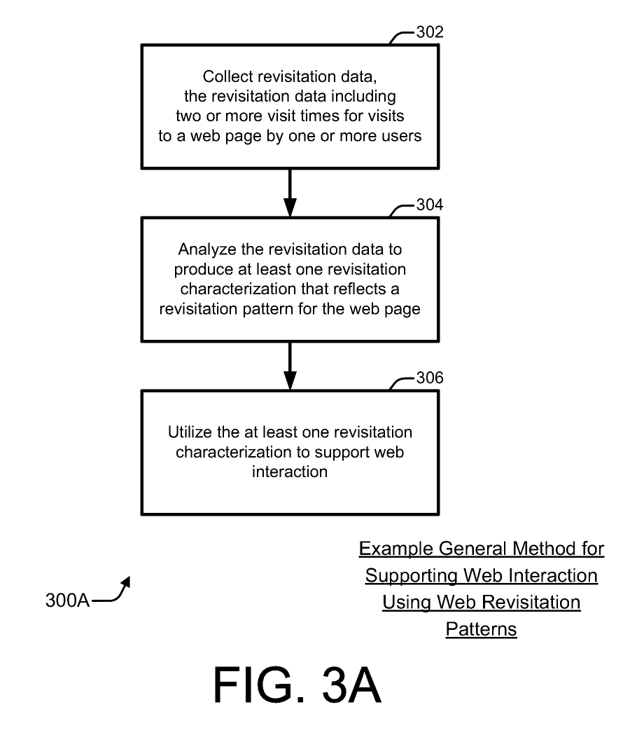

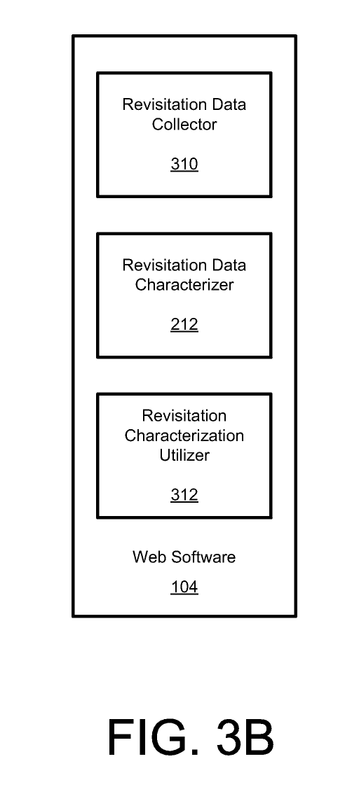

FIG. 3A is a flow diagram 300A that illustrates an example of a general method for supporting web interaction using web revisitation patterns. Flow diagram 300A includes three (3) blocks 302-306. Implementations of flow diagram 300A may be realized, for example, as processor-executable instructions and/or as part of web software 104 (of FIG. 1), including at least partially by a revisitation data characterizer 212 (of FIG. 2). More detailed example embodiments for implementing flow diagram 300A are described herein below.

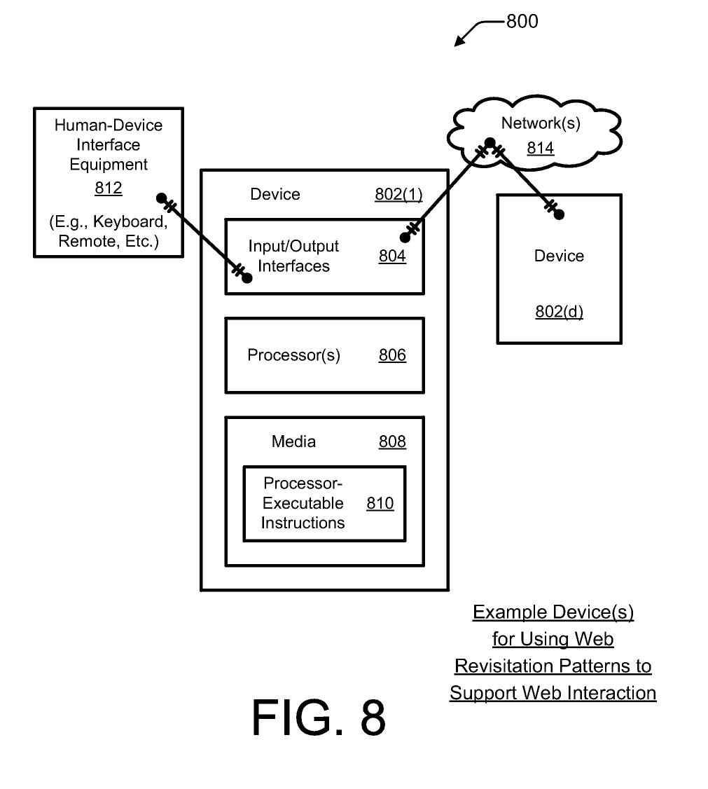

The acts of the various flow diagrams that are described herein may be performed in many different environments and with a variety of different devices, such as by one or more processing devices (of FIG. 8). The orders in which the methods are described are not intended to be construed as a limitation, and any number of the described blocks can be combined, augmented, rearranged, and/or omitted to implement a respective method, or an alternative method that is equivalent thereto. Although specific elements of other FIGS. are referenced in the description of the flow diagrams, the methods may be performed with alternative elements.

In an example embodiment, at block 302, revisitation data is collected, with the revisitation data including two or more visit times for visits to a web page by one or more users. For example, measured revisitation data 202 may be collected, with measured revisitation data 202 including two or more visit times 208 for visits to a web page 102 by one or more users 106. The data may be collected directly or indirectly. For instance, a web browser may indirectly collect measured revisitation data 202 by acquiring revisitation data for other users from a web server or search engine. Similarly, a web server or search engine may indirectly collect measured revisitation data 202 by acquiring it from a browsing history of a web browser or from a browser plug-in.

At block 304, the revisitation data is analyzed to produce at least one revisitation characterization that reflects a revisitation pattern for the web page. For example, measured revisitation data 202 may be analyzed to produce at least one revisitation characterization 214 that reflects a revisitation pattern 110 for web page 102. Example implementations for characterizing revisitation data that relate to producing revisitation curves are described herein below with particular reference to FIGS. 4A-4E.

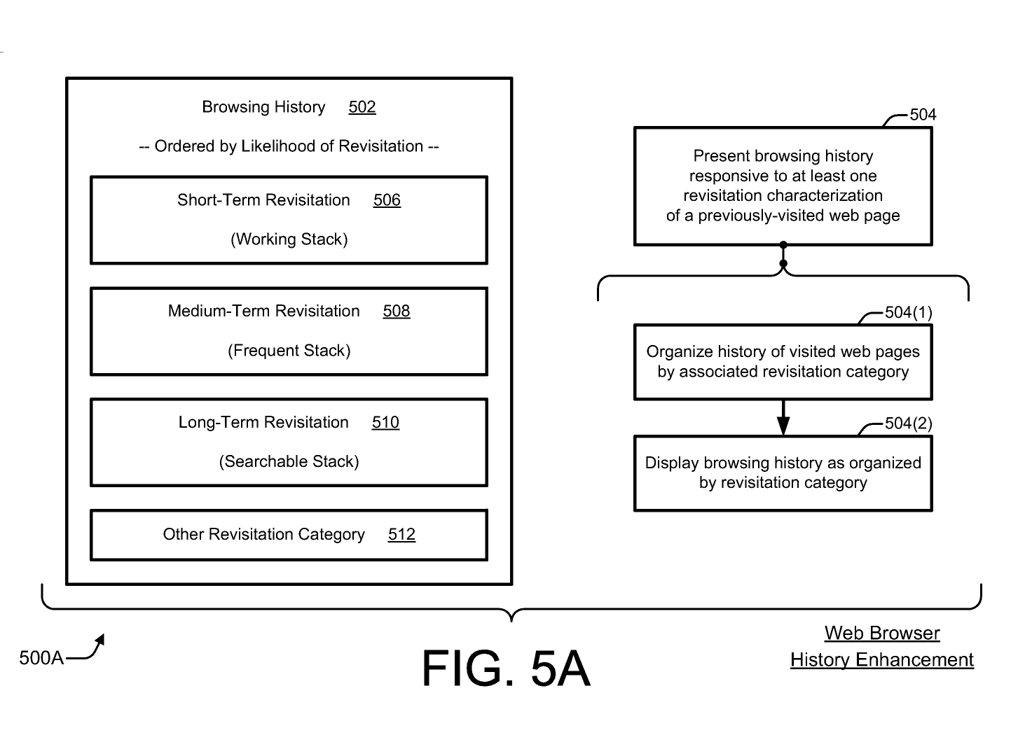

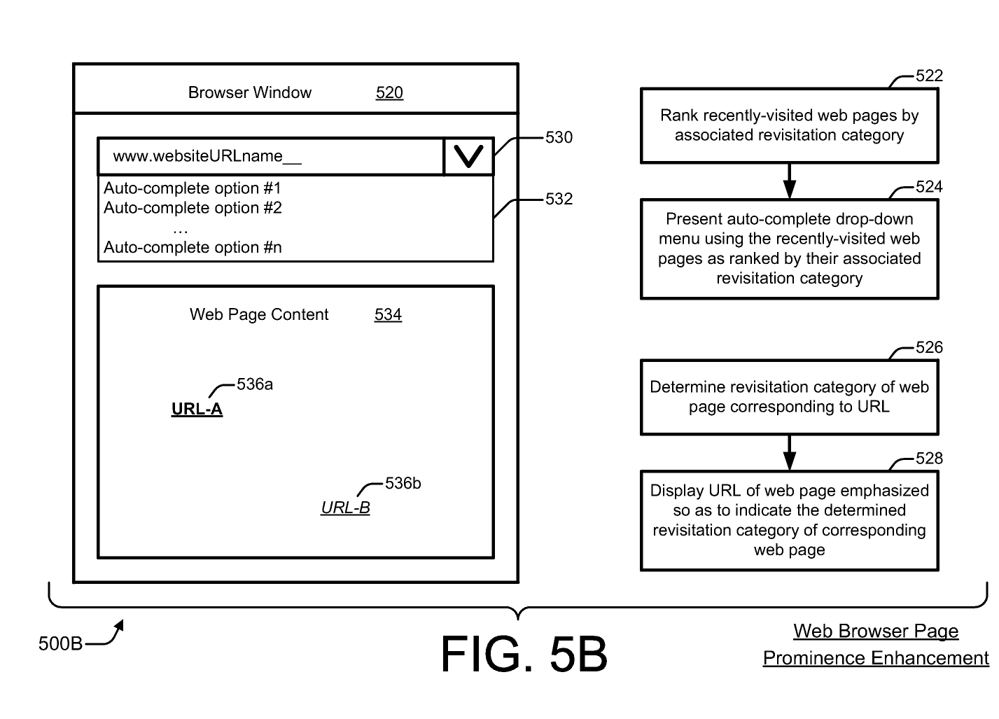

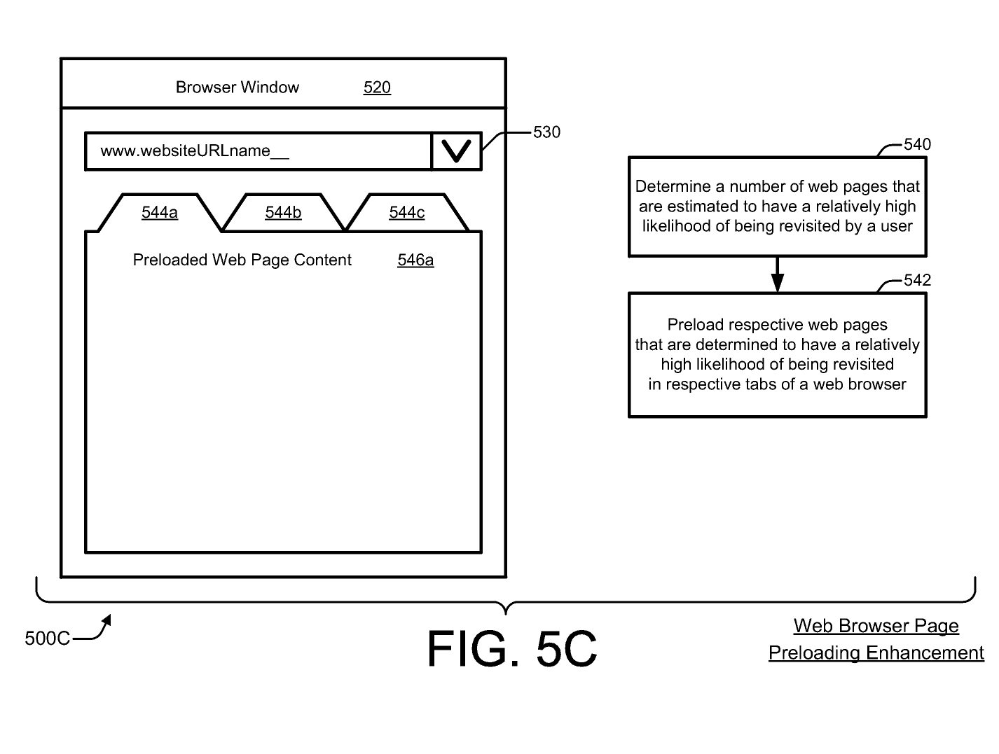

At block 306, the at least one revisitation characterization is utilized to support web interaction. For example, revisitation characterization 214 may be utilized to support web interaction by a user 106. Example implementations for utilizing revisitation characterizations 214 to support web interaction are described herein below with particular reference to FIGS. 5A-7.

FIG. 3B is an example of web software 104 that is capable of implementing a general method for supporting web interaction using web revisitation patterns. As illustrated, web software 104 includes a revisitation data collector 310, a revisitation data characterizer 212, and a revisitation characterization utilizer 312. As described above, web software 104 may comprise web browser web software 104(WB), search engine web software 104(SE), web site web software (not separately shown), web crawler web software (not separately shown), a combination thereof, and so forth. More generally, web software 104 may be realized as web-oriented processor-executable instructions that may be embodied as software, firmware, hardware, fixed logic circuitry, some combination thereof, and so forth.

In an example embodiment of web software 104, revisitation data collector 310 is to collect revisitation data, with the revisitation data including two or more visit times for visits to a web page by one or more users. Revisitation data characterizer 212 is to analyze the revisitation data to produce at least one revisitation characterization that reflects a revisitation pattern for the web page. Revisitation characterization utilizer 312 is to utilize the revisitation characterization to support web interaction. Example implementations for utilizing revisitation characterizations to support web interaction are described herein below with particular reference to FIGS. 5A-7.

### 3: Example Revisitation Curve Implementations for Supporting Web Interaction

To compare and evaluate revisitation patterns for different web pages, a revisitation curve may be used. Generally, a revisitation curve represents the inter-visit times (e.g., revisit periods) to a web page by at least one user to reflect the revisitation pattern. More specifically, a revisitation curve may be a normalized histogram of inter-visit times for multiple users that are visiting (and revisiting) a specific web page to characterize the page's revisitation pattern.

FIG. 4A depicts at 400A generally a pair of graphs showing inter-visit times 404 for constructing an example revisitation curve 218. The upper graph 402 plots visits and represents time along the abscissa axis (x-axis) and a visit along the ordinate axis (y-axis). Each visitation time 208 represents a time-stamped interaction with the corresponding web page by a user. Seven visitation times 208 are graphed at the following time units: 2, 4, 8, 9, 10, 11, and 14. (There is also an initial visit at time=0 along the ordinate axis.)

Inter-visit times 404 represent the revisit period between two (e.g., consecutive) visitation times 208. An average of the inter-visit times 404 for one or a number of users may be employed as the average inter-visit time 216c (of FIG. 2). With “×” representing one time unit, the seven illustrated inter-visit times 404 are, from left to right: 2×, 2×, 4×, ×, ×, ×, and 3×. In revisits graph 402, there are therefore three inter-visit times 404 of × duration, two inter-visit times 404 of 2× duration, and one inter-visit time 404 of both the 3× and 4× durations.

The lower graph 406 is a histogram that represents inter-visit times along the abscissa axis and counts along the ordinate axis. The inter-visit times 404 of revisits graph 402 are plotted on histogram graph 406 as inter-visit time plots 408. Hence, from revisits graph 402, there are three counts at the 1× inter-visit mark, two counts at the 2× inter-visit mark, one count at the 3× inter-visit mark, and one count at the 4× inter-visit mark. The four inter-visit time plots 408 on histogram graph 406 define a curve, revisitation curve 218.

FIG. 4B depicts at 400B generally four example graph pairs (a)-(d) for constructing four different revisitation curves. There are revisit graphs 402 on the left and histogram graphs 406 on the right. Each revisit graph 402 includes four visitation times 208. The four graph pairs at 400B thus illustrate the relationship between page visits and revisitation curves. For each graph pair (a)-(d), four page visits are represented at four visitation times 208 as four bars along a time line. The resulting revisitation curve 218 is a histogram of the inter-visit times. In histogram graphs 406, the abscissa axis represents the inter-visit time interval, and the ordinate axis represents a count of the number of visits to the web page separated by that interval. The bars in the histogram graphs 406 are thus of different heights, depending on the count total (e.g., one, two, or three).

The specific density of visits determines the shape of the revisitation curve 218. For example, the web page corresponding to the first graph pair (a) has four visits in rapid succession, and none at longer intervals. Hence, the revisitation curve 218 for graph pair (a) shows a high number of revisitations in the smallest interval bin. In contrast, visits in the second graph pair (b) are spread out, which shifts the peak of the revisitation curve 218 to the right (corresponding to a higher inter-arrival time bin). The third graph pair (c) includes two fast repeat visits and one long inter-visit time. The fourth graph pair (d) includes inter-visit times of varying lengths.

In short, graph pair (a) has rapid repeat visits, graph pair (b) has slower repeat visits, graph pair (c) has a mix of fast and slow repeat visits, and graph pair (d) has variable times between repeat visits. It should be noted that the number of visits in each graph pair is the same. Thus, the same number of visits per user can result in very different revisitation curves 218.

By way of specific example, revisitation curves may be generated first by calculating the inter-arrival times between consecutive pairs of revisits. Exponential bins may be used to characterize the inter-arrival times. Manual tuning of the bin boundaries may be employed to generate more descriptive timescales. Comprehendible boundaries may be, for example: one minute, five minutes, ten minutes, half an hour, one hour, two hours, eight hours, one day, two days, one week, two weeks, and a month. It should be noted that even if a histogram graph is not literally constructed, binning inter-visit times can facilitate further analysis when producing a revisitation characterization.

Because histograms are count based, web pages that have many more visitors and/or more revisits per visitor will have higher counts. In order to compare revisitation patterns between such web pages, their revisitation curves may be normalized. By way of example, each individual curve may be normalized by the centroid (i.e., the average) of each of the curves. To complete the normalization, for each web page the un-normalized bins in each revisitation curve are divided by the corresponding count in the centroid. Thus, for each bin, i:

(normalized) revisit-curve_{page}[i]=count_{page}[i]/centroid[i].

From a high-level perspective, the normalized revisitation curve for each web page roughly represents the percentage over, or under, revisits to that web page as compared to the average revisitation pattern. Although normalization is achieved with the equation above by dividing out the centroid, there are a number of other ways to normalize this type of data that may be implemented. Alternative examples include normalizing to a 0-1 range, subtracting out the centroid, and so forth. As described further below, however, normalizing by finding a quotient with the centroid enables both comparisons and groupings of the different revisitation behavior patterns. It should be noted that data may be cleaned in other ways, instead of or in addition to normalizing. Example data cleansing approaches include, but are not limited to, normalizing the data, removing spurious and/or noisy data, extrapolating/interpolating the data, averaging the data, combinations thereof, and so forth.

FIG. 4C is a flow diagram 400C that illustrates an example of a method for constructing a revisitation curve. Flow diagram 400C includes seven blocks 420-432. Implementations of flow diagram 400C may be realized, for example, as processor-executable instructions and/or as part of web software 104 (of FIG. 1), including a revisitation data characterizer 212 (of FIG. 2).

In an example embodiment, at block 420, user visit times for a web page are acquired. For example, visit times 208 corresponding to a user identification 204 and a page identification 206 may be acquired. At block 422, inter-visit times are ascertained from the user visit times. For example, inter-visit times 404 may be ascertained from user visit times 208.

At block 424, inter-visit times are assigned to bins of a histogram. For example, inter-visit times 404 may be assigned to bins of a histogram graph 406. At block 426, counts of inter-visit times are plotted to the histogram graph based on the assigned bins. For example, the counts per inter-visit time 404 may be plotted as inter-visit time plots 408 on histogram graph 406.

At block 428, it is determined if there is revisitation data for another user. For example, it may be determined if there is additional measured revisitation data 202 for a different user identification 204 that corresponds to the same page identification 206. If so, the method of flow diagram 400C continues at block 420.

If, on the other hand, it is determined (at block 428) that there is no additional revisitation data for analysis, then flow diagram 400C continues at block 430. At block 430, a revisitation curve for the web page is built responsive to the plotted counts. For example, a revisitation curve 218 may be built from the inter-visit time plots 408. Additionally, at block 432, the revisitation curve may be normalized for standardized comparisons. For example, revisitation curve 218 may be normalized using, e.g., a centroid for a number of revisitation curves to enable a standardized comparison between and among different revisitation curves corresponding to different web pages.

Examples of revisitation curves for two specific web pages are:

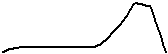

—for a popular general-interest internet retailer that offers an expansive number of product categories. This revisitation curve peaks towards the right, which indicates that most revisits occur after a relatively longer time period (e.g., over a day).

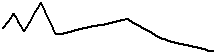

—for a well-known news site that covers general national news. This revisitation curve displays a peak on the left, which is perhaps driven by automatic reloads, along with a higher middle region, which is perhaps due to users checking for the latest news.

Each revisitation curve may be considered to be a signature of user behavior with respect to accessing a corresponding web page. Given a revisitation curve representation of user behavior, the range of such curves may be investigated. To organize these curves, a clustering algorithm may be applied to recognize curves that have similar shapes and/or magnitudes. Specifically, and by way of example, a repeated-bisection clustering with a cosine similarity metric and the ratio of intra- to extra-cluster similarity as the objective function may be used. Experimental investigation indicates that clusters are fairly stable regardless of the specific clustering or similarity metric. Thus, alternative clustering approaches and/or similarity metrics may be employed to investigate commonalities and differences between and among revisitation curves.

By varying the number of clusters and testing within- and between-cluster similarity, it has been discovered that the objective function levels off at around 12 clusters. Although 12 clusters were discovered for approximately a month's worth of revisitation data, longer data collection periods may result in raw visitation data that produces a different total number of clusters. These 12 clusters are graphically presented in Table 2 below and are designated by F1-F5, M1-M2, S1-S4, and H1. As shown in Table 2, these 12 clusters have been further ordered, named, and manually grouped based on general trends into four groups: fast, medium, slow, and hybrid. These four revisitation curve group categories 218a (of FIG. 2) are described at a relatively high level herein below with particular reference to FIG. 4D.

Many revisitation patterns were located at the extremes. Five clusters F1-F5 represented primarily fast revisitation patterns, in which people revisited the associated member web pages many times over a short interval but rarely revisited over longer intervals. On the other hand, four clusters S1-S4 represented slow revisitation patterns, with people revisiting the associated member pages mostly at intervals of a week or more. Between these two extremes are two other groups of clusters. One is a hybrid combination cluster H1 of fast and slow revisitations; it displays a bimodal revisitation pattern. The other group includes two medium clusters M1-M2 having web pages that are revisited primarily at intervals of between an hour and a day. The clusters in this medium group are less peaked and show more variability in revisitation intervals than the fast or slow groups.

Table 2 below presents and describes four example revisitation curve group categories: fast, medium, slow, and hybrid. Each group category may be further subdivided into revisitation clusters. Twelve example revisitation clusters are shown: F1, F2, F3, F4, F5, M1, M2, S1, S2, S3, S4, and H1. A general example description of each grouped category is also presented.

TABLE 2
Example revisitation curve group
categories and cluster subdivisions.

| Cluster Group | Name | Shape | Description |
|---|---|---|---|
| Fast Revisits (< hour) 23611 pages | F1 | 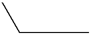 | Pornography & Spam, Hub & Spoke, Shopping & Reference Web sites, Auto refresh, Fast monitoring |
| | F2 | 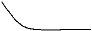 | |
| | F3 | 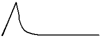 | |
| | F4 | 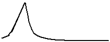 | |
| | F5 | 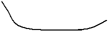 | |
| Medium (hour to day) 9421 pages | M1 | 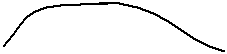 | Popular homepages, Communication, .edu domain, Browser homepages |
| | M2 | 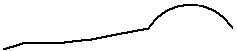 | |
| Slow Revisits (> day) 9421 pages | S1 | 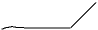 | Entry pages, Weekend activity, Search engines used for revisitation, Child-oriented content, Software updates |
| | S2 | 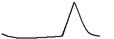 | |
| | S3 | 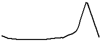 | |
| | S4 | 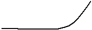 | |
| Hybrid 3334 pages | H1 | 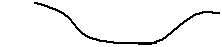 | Popular but infrequently used, Entertainment & Hobbies, Combined Fast & Slow |

As noted above, a portion of the investigation and analysis into web page revisitation included the dissemination of surveys. The self-reported, survey-based revisitation data reinforced the selection of this grouping criteria as revisitation patterns from the surveys were fairly consistent, not only with each individual participant's observed page interactions, but also with overall patterns in the aggregate log data. Participants tended to report hourly or daily visits to web pages that were clustered as fast or medium-term revisitation. They tended to report weekly, monthly, or longer revisits to those web pages categorized as having slow revisitation patterns. The self-reported regularity of access decreased as the visitation interval increased. Participants reported visiting medium web pages at regular intervals and slow web pages at irregular intervals.

FIG. 4D depicts at 400D generally four example revisitation curves 218 that reflect four group categories. These revisitation curve group categories 218a (of FIG. 2) are graphed on four histogram graphs 406. Each histogram graph 406 represents inter-visit time along the abscissa axis and revisit counts along the ordinate axis. The inter-visit time of the abscissa axis is graphed on a logarithmic scale with time units (T) that are explicitly denoted at 1T, 10T, 100T, and 1000T.

Each of the revisitation curves 218 in FIG. 4D represents a general example curve for a group category. Individual revisitation curves may vary while still fitting within a given group category. A fast revisitation group category is reflected by fast revisitation curve 218(F). It resembles a downward sloping ramp on the left and is relatively flat in the center and right portions. As indicated in Table 2 above, a revisitation curve may differ from revisitation curve 218(F) and nevertheless be classifiable within the fast revisitation group category. For instance, the left portion may resemble a peaked mountain (e.g., clusters F3 and F4) having both upward and downward ramp shapes instead of merely a downward ramp shape.

A medium revisitation group category is reflected by medium revisitation curve 218(M). It resembles a hill shape that is higher in the central portion and lower at the right and left portions. A slow revisitation group category is reflected by slow revisitation curve 218(S). It resembles an upward sloping ramp on the right and is relatively flat in the left and center portions. A hybrid revisitation group category is reflected by hybrid revisitation curve 218(H). It resembles a valley shape that is lower in the central portion and higher at the right and left portions.

FIG. 4E is a block diagram of an example approach 400E to assigning a revisitation curve group category 218a to measured revisitation data 202. The example revisitation curve group categories, which are described above and illustrated in FIG. 4D and which were identified through clustering, can be used to label measured revisitation data 202 to aid in understanding a particular page's web revisitation pattern, to organize web pages by revisitation curve group category, and so forth. As illustrated, approach 400E includes measured revisitation data 202, a label for revisitation curve group category 218a, a learning machine categorizer 440, and revisitation cluster grouping information 442.

In an example embodiment, measured revisitation data 202 is input to learning machine categorizer 440. After analysis in accordance with its learning algorithm, learning machine categorizer 440 outputs a label for revisitation curve group category 218a that reflects the input revisitation data. Using the revisitation curve group categories of FIG. 4D, the label may be, for example, fast revisitation, medium revisitation, slow revisitation, or hybrid revisitation. For training purposes, revisitation cluster grouping information 442, which may be derived from application of a clustering algorithm to revisitation data, is applied to learning machine categorizer 440. By way of example, learning machine categorizer 440 may be powered by any learning algorithm, such as a support vector machine (SVM), neural networks, genetic algorithms, K-nearest neighbor algorithms, decision trees, a combination or kernelized version thereof, and so forth.

With reference to the act(s) of block 304 (of FIG. 3A), analysis may include applying measured revisitation data 202 from one or more users for a web page to a learning machine categorizer 440 and producing a revisitation curve group category 218a label that constitutes a revisitation characterization 214. The revisitation curve group category label may be, for example, fast revisitation, medium revisitation, slow revisitation, or hybrid revisitation. This revisitation curve group category is associated with the web page and may then be utilized to support web interaction.

### 4: Example Embodiments for Utilizing Revisitation Characterizations

Utilization of revisitation characterization(s) is described herein above with particular reference to the act(s) of block 306 (of FIG. 3A) and revisitation characterization utilizer 312. This functionality may be realized by web software 104. Example embodiments of such web software 104 include, by way of example, a web browser, a search engine, a web crawler, a web site analyzer, a combination thereof, and so forth. In this section, various example implementations for each of these embodiments are described in subsection 4.1 (web browsers), in subsection 4.2 (search engines with web crawling capability), and in subsection 4.3 (web sites). It should be understood that these embodiments and the specific described implementations thereof are included by way of example only. Example embodiments may be realized in many different alternative manners.

### 4.1: Web Browsers

FIG. 5A is a block diagram 500A illustrating an example of how a web browser can support web interaction by using web revisitation patterns with respect to a browsing history 502. As illustrated, diagram 500A includes browsing history 502 and three action blocks 504, 504(1), and 504(2). In an example embodiment, browsing history 502 is ordered by a likelihood of revisitation. Generally, a web browser can support web interaction with respect to a browsing history by presenting the browsing history responsive to at least one revisitation characterization of a previously-visited web page (block 504). Moreover, any general application may present the browsing history responsive to the at least one revisitation characterization of a previously-visited web page.

By way of example, web interaction can be supported by organizing a history of visited web pages by their associated revisitation category (block 504(1)) and displaying a browsing history as organized by the associated revisitation category of the previously-visited web pages (block 504(2)). A revisitation category may be, for instance, a revisitation curve category. A revisitation curve category or categorization may be, for instance, directed to the cluster level, the group level, and so forth.

Example revisitation curve categories that are directed to the group level include fast, medium, and slow revisitation, as is described herein above with particular reference to FIGS. 4A-4E. Browsing history 502 is organized and ordered in accordance with these three categories as an example implementation. A short-term revisitation category 506 represents a working stack of web pages and corresponds to the fast revisitation curve category. A medium-term revisitation category 508 represents a frequent stack of web pages and corresponds to the medium revisitation curve category. A long-term revisitation category 510 represents a searchable stack of web pages and corresponds to the slow revisitation curve category. An “other” revisitation category 512 corresponds to web pages in other categories such as the hybrid revisitation curve category or to web pages having an unknown revisitation pattern. Other embodiments may alternatively be implemented. For example, fast revisitation pages may be displayed in another region of a browser window to aid short-term navigation.

Historic functionality with respect to web page revisitation can also be extended to include predictive functionality. Given a characterization of revisitation behavior to a web page (either on a local or a global scale) and a characterization of an individual's visits to that web page, future use of the web page can be predicted, and the web page or references thereto may be presented to the individual user based on the prediction. For example, if a person historically visits his or her bank's web page every month, then when three and a half weeks have passed since that web page was last visited, it can be made particularly prominent for the user. Examples of predicative functionality that are at least partially based on web page revisitation are described below with particular reference to FIGS. 5B and 5C.

FIG. 5B is a block diagram 500B illustrating an example of how a web browser can support web interaction by using web revisitation patterns with respect to web page prominence. As illustrated, diagram 500B includes a browser window 520 and four action blocks 522-528. Browser window 520 includes a web page address block 530 and an auto-complete drop-down menu 532. The current address in web page address block 530 indicates the current web page for web page content 534. The choices in auto-complete drop-down menu 532 are options that may be selected to complete a partially-entered web page address name. These options #1, #2 . . . #n are typically web page address names that have been recently visited and are traditionally listed in a most-recently-used (MRU) order.

For an example implementation, a web browser ranks recently-visited web pages by respective associated revisitation categories (block 522). The web browser (or another, e.g. general, application) presents an auto-complete drop-down menu 532 using the recently-visited web pages as ranked by their respective associated revisitation categories (block 524). This ordering can place a web page address of a web page that is more, if not most, likely to be revisited soon, if not next, at the top of auto-complete drop-down menu 532.

For another example implementation, a web browser determines a revisitation category of a web page corresponding to a URL (block 526). The web browser displays the URL 536a,b of the web page in an emphasized format so as to indicate the determined revisitation category of the corresponding web page (block 528). The determination may be a direct determination effectuated by the web browser through local collection and analysis and/or it may be an indirect determination effectuated at least partially by a remote server with the revisitation category being accessible to the web browser.

The emphasis format may be realized in any of many different forms. Example emphasis formats include, but are not limited to, color changes, font changes, point-size changes, bold/underline/italics, combinations thereof, and so forth. As shown, the bold URL 536a may indicate, for instance, a fast revisitation category while the italicized URL 536b may indicate a medium revisitation category. Other combinations may alternatively be implemented.

FIG. 5C is a block diagram 500C illustrating an example of how a web browser can support web interaction by using web revisitation patterns with respect to web page preloading. As illustrated, diagram 500C includes a browser window 520 and two action blocks 540-542. Browser window 520 includes a web page address block 530 and three browser tabs 544a, 544b, and 544c. Although three tabs 544 are specifically shown, browser window 520 may contain more or fewer such tabs 544. Generally, a web browser (or another application) may be configured to present web pages or their corresponding URLs responsive to an estimated likelihood of revisiting the web pages. The presentation may be incorporated into a browsing history, into an auto-complete drop-down menu, into browser tabs, and so forth.

For an example implementation, each respective tab 544 includes respective preloaded web page content 546. Because tab 544a is currently selected for viewing, preloaded web page content 546a is visible within tab 544a. A web browser determines a number of web pages that are estimated to have a relatively high likelihood of being revisited by a user (block 540). The web browser then preloads respective web pages that are determined to have a relatively high likelihood of being revisited in respective tabs 544 of browser window 520 (block 542).

The number of preloaded web pages may be preset or may be adjustable based on user specification, based on a monitored heuristic, and so forth. A relatively high likelihood for a revisitation may be realized in a number of different manners. For example, it may be equated to those “n” web pages having the highest likelihood of revisitation from a set of previously-visited web pages, with “n” being the aforementioned number. Alternatively, it may be those web pages having a likelihood of revisitation that exceeds a predetermined statistical threshold. Other criteria may also be implemented.

### 4.2: Search Engine

Search engines may also be adapted to support web interaction using web revisitation patterns. For example, revisitation characterizations may impact search engine functionality in a number of areas. Such areas include query analysis, search result ranking and/or re-ranking, presentation of a set of search results, advertisement selection, scheduling of an integrated or associated web crawler, and so forth. Generally, a search engine may perform a web search for an input query responsive to the at least one revisitation characterization to produce a set of search results.

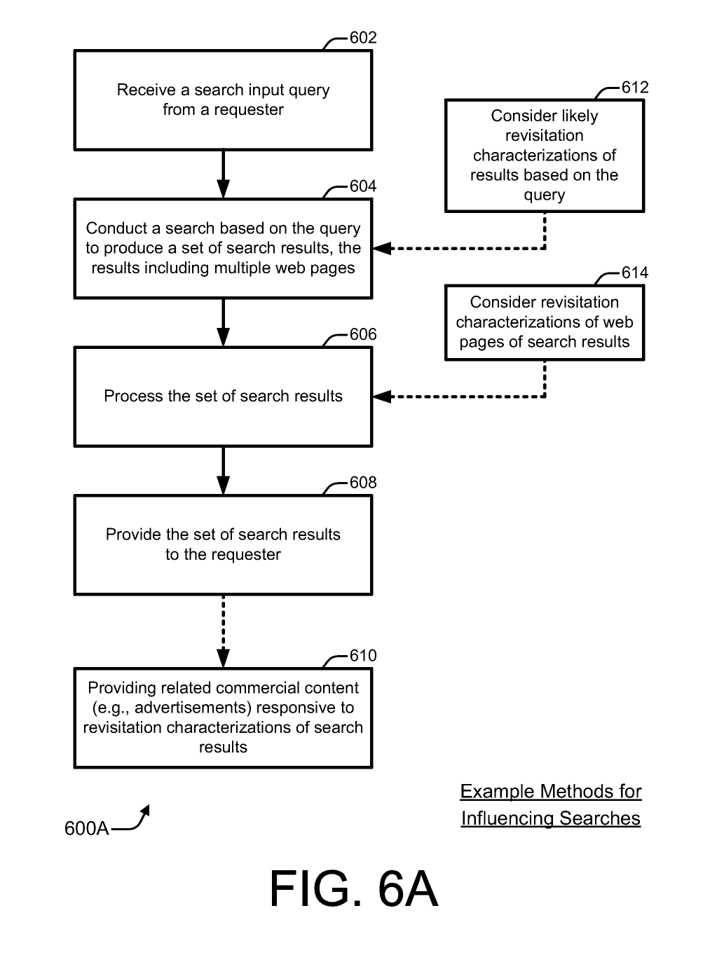

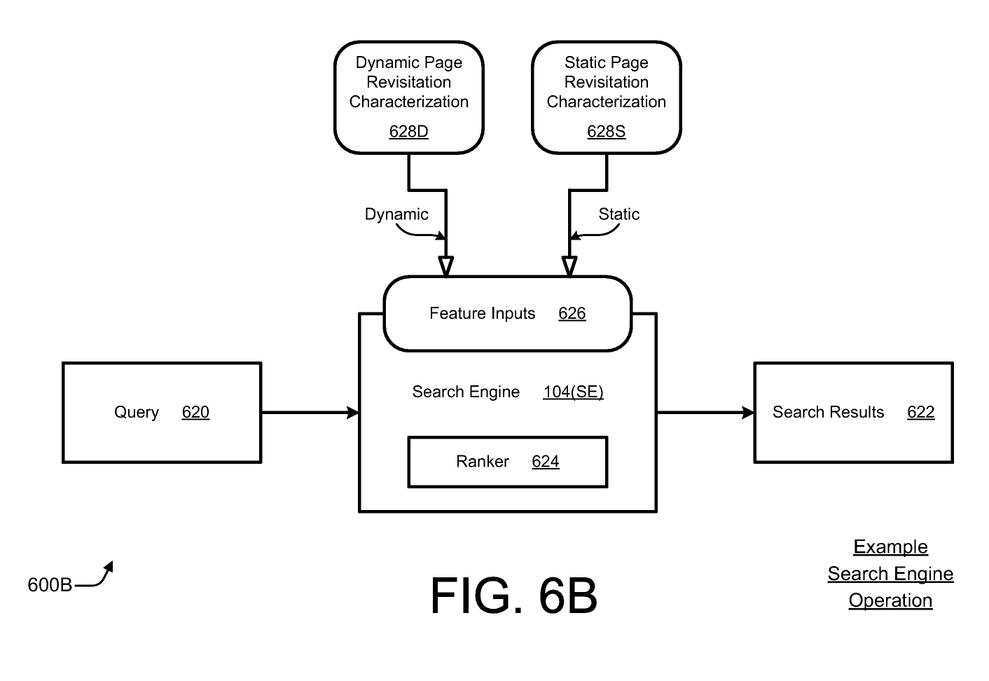

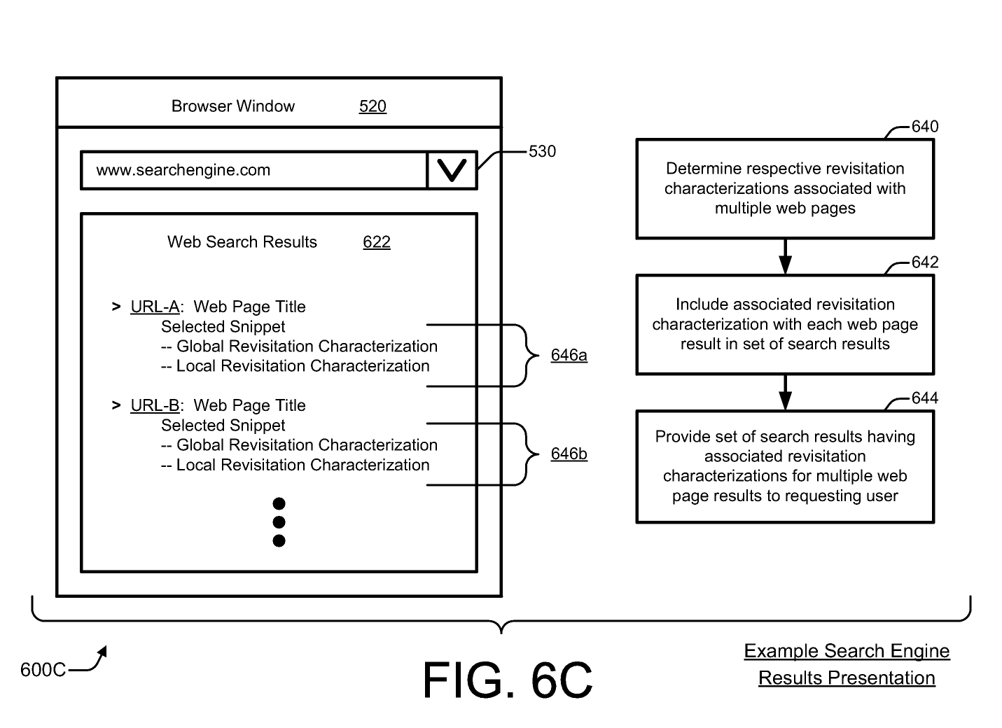

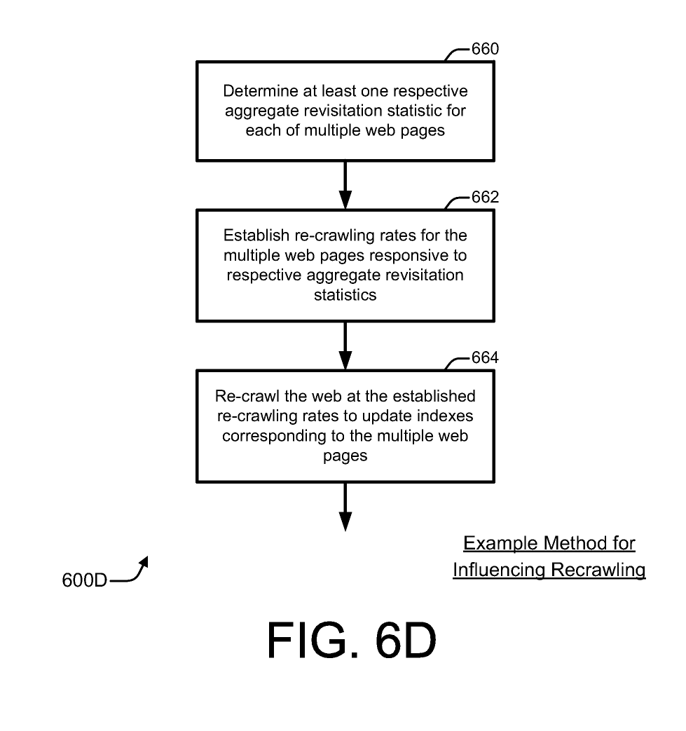

A search engine may also predict and produce a set of web pages that an individual will likely wish to revisit responsive to at least one revisitation characterization without an input query. Such a predictive set of web pages may be presented when a user first loads a web page (e.g. a homepage) of a search engine and/or when a user activates the search engine functionality without first inputting an actual query. Other more specific example implementations for search engine embodiments are described below with reference to FIGS. 6A-6D.

FIG. 6A is a flow diagram 600A that illustrates examples of general methods for a search engine to support web interaction by using web revisitation patterns. Flow diagram 600A includes seven blocks 602-614. For example implementations, at block 602, a search input query is received from a search requester. At block 604, a search is conducted based on the query to produce a set of search results, the set of search results including multiple web pages.

Prior to or during the acts of block 604, at block 612, the search engine considers likely revisitation characterizations of the results based on the input query. For example, the content of some input queries are more likely to produce search results, and/or the content indicates that the search requester is more likely to want search results, that have a fast revisitation pattern. For instance, the word “shop” or “store” may be present in the input query.

At block 606, the search results may be further processed, such as by re-ranking them. Prior to or during the acts of block 606, at block 614, the search engine considers revisitation characterizations of the web pages included in the search results. For example, it may be useful to harmonize the higher-ranked search results so that they are from the same revisitation category, or it may be useful to ensure that different revisitation categories are each represented in the higher-ranked search results.

At block 608, the set of search results is provided to the search requester. At times, search results are augmented with general and/or related content. This related content may be advertisements, suggested web pages that may be of interest, and so forth. At such times, related commercial content (e.g., advertisements) may be provided responsive to the revisitation characterizations of the web pages of the search results at block 610.

FIG. 6B is a block diagram 600B that illustrates an example of an operation for a search engine to support web interaction by using web revisitation patterns. As illustrated, diagram 600B includes search engine web software 104(SE), a query 620, search results 622, and page revisitation characterization(s) 628. Search engine 104(SE) includes a ranker 624 and feature inputs 626.

For an example implementation, query 620 is input to search engine 104(SE). Based on query 620, search engine 104(SE) conducts a search using ranker 624 responsive to feature inputs 626. The output of the search is search results 622, which typically includes multiple web pages. Feature inputs 626 enable the operation of search engine 104(SE), along with ranker 624 thereof, to be tuned. Although two such feature inputs are explicitly shown, it should be understood that there may be many such feature inputs (e.g., tens, hundreds, or more).

In this example, two feature inputs are shown: a dynamic or query-dependent page revisitation characterization 628D and a static or query-independent page revisitation characterization 628 S. These page revisitation characterization(s) 628 affect the search operation of search engine 104(SE) by influencing the search results to gravitate toward a particular revisitation pattern that is reflected in the stipulated revisitation characterization features. These page revisitation characterization(s) may be static, which are unrelated to query 620, or dynamic, which are query-dependent. The targeted feature inputs may be local or global. Local pertains to an individual user or machine or to a defined group of people. Global pertains to internet users at large. Also, the heuristics involving page revisitation characterization features may be applied before or after the initial ranking.

FIG. 6C is a block diagram 600C that illustrates an example of a search engine supporting web interaction by using web revisitation patterns with regard to presenting search results. As illustrated, diagram 600C includes a browser window 520 and three action blocks 640-644. Browser window 520 includes a web page address block 530 and web search results 622 in a window pane thereof. Although this implementation relates primarily to a search engine, the visible manifestation is presented within a browser window 520, as is shown in FIG. 6C. It may also be presented within the window of another application.

For an example implementation, a search engine determines respective revisitation characterizations associated with multiple respective web pages (block 640). The search engine includes the associated revisitation characterization with each web page result in a set of search results (block 642). The search engine then provides the set of search results having respective associated revisitation characterizations for multiple web page results to a requesting user (block 644). Many different search result displays can be supported, for example, as part of the selected snippets, other information (e.g., 646a and 646b), or in a separate filter pane (not shown).

As shown in the web search results 622 pane of browser window 520, the web browser then displays these revisitation characterizations as part of the search results. A respective global revisitation characterization corresponding to a group of users and/or a respective local revisitation characterization corresponding to an individual user (when available) is displayed at 646a and 646b in association with each respective web page of the set of web search results 622. With regard to the selected snippet for each web page search result, the snippet may be selected responsive to the revisitation characterization(s). For example, a snippet may be selected to show content that has become available on the search result web page since the searching user last visited the web page. Search results may also be grouped together based on common global or local revisitation characterizations.

FIG. 6D is a flow diagram 600D that illustrates an example of a method for a search engine to support web interaction by using web revisitation patterns with regard to scheduling web re-crawling or targeting a focused discovery of new pages to crawl. Flow diagram 600D includes three blocks 660-664. The acts of flow diagram 600D may be performed by web crawler web software that is integral with or separate from search engine web software. Moreover, the acts of blocks 660 and/or 662 may be performed by non-web-crawling software, such as a separate search engine, one or more web browsers, and so forth.

For an example implementation, at block 660, at least one respective aggregate revisitation statistic is determined for each of multiple web pages. For example, at least one aggregate revisitation statistic 216 (of FIG. 2) for each web page 102 (of FIG. 1) may be determined by web software 104 (e.g., a search engine and/or a web crawler). At block 662, re-crawling rates for respective ones of the multiple web pages are established responsive to respective aggregate revisitation statistics. At block 664, the web crawler re-crawls the web at the established respective re-crawling rates to update indexes corresponding to respective ones of the multiple web pages. Other example web revisitation implementations in the context of search engines include, but are not limited to, determining page quality or importance, identifying spam-related pages, and so forth.

### 4.3: Web Site

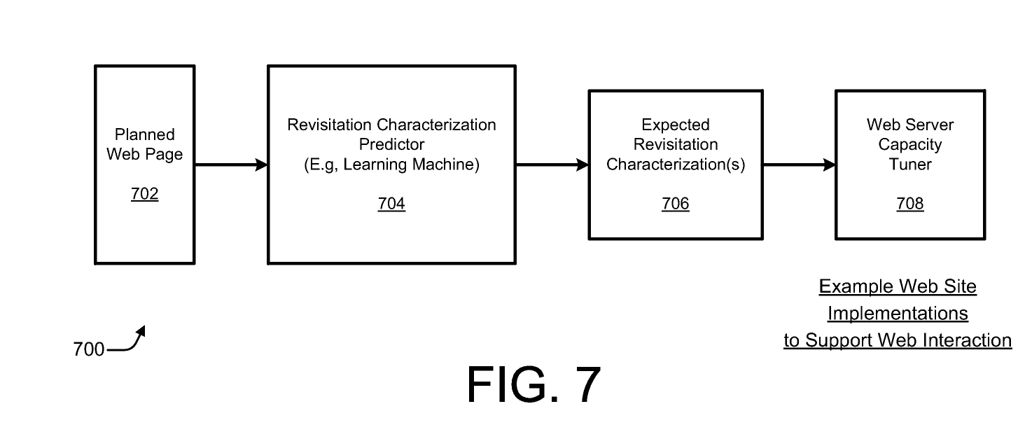

FIG. 7 is a block diagram 700 that illustrates examples for a web site to support web interaction using web revisitation patterns. As illustrated, diagram 700 includes a planned web page 702, a revisitation characterization predictor 704, one or more expected revisitation characterizations 706, and a web server capacity tuner 708. Planned web page 702 corresponds to web page 102 (of FIG. 1), but planned web page 702 is not yet released for general access. Expected revisitation characterizations 706 correspond to revisitation characterizations 214 (of FIG. 2), but they are predicted versions as opposed to being the result of measured revisitation data.

For example implementations generally, a web site may report and/or expose for retrieval revisitation characterizations 214. Other web software, such as search engines and web browsers, may then utilize such information. This self-collected revisitation characterizations 214 may also be compared to expected revisitation characterizations 706 to determine if the current web site design is meeting web access goals for the intended users.

With reference to diagram 700, for an example implementation, planned web page 702 is input to revisitation characterization predictor 704. Revisitation characterization predictor 704 may be, for example, a learning machine that has been trained to predict revisitation characterizations 214 from the content, layout, etc. of a web page. Revisitation characterization predictor 704 outputs one or more expected revisitation characterizations 706. These expected revisitation characterizations 706 may be input to web server capacity tuner 708. Based on the expected revisitation characterizations 706, a web server that is executing web server capacity tuner 708 may plan for and thus accommodate forthcoming web accesses by users. Other example web revisitation implementations in the context of web site analysis include, but are not limited to, reporting web site activity organized by revisitation category, reporting revisitation pattern changes over time, reporting revisitation patterns for different demographic groups, and so forth.

### 5: Example Device Implementations for Using Web Revisitation Patterns

FIG. 8 is a block diagram 800 of an example device 802 that may be used to implement embodiments for supporting web interaction using web revisitation patterns. As illustrated, two devices 802(1) and 802(d) are capable of engaging in communications via network(s) 814. Although two devices 802 are specifically shown, one or more than two devices 802 may be employed, depending on implementation. For instance, one device 802 may implement a web browser while another device 802 may implement a web server, a web site, a web crawler, and so forth. Network(s) 814 may be, by way of example but not limitation, an internet, an intranet, an Ethernet, a public network, a private network, a cable network, a digital subscriber line (DSL) network, a telephone network, a wireless network, some combination thereof, and so forth.

Generally, a device 802 may represent any computer or processing-capable device, such as a server device, a workstation or other general computer device, a personal digital assistant (PDA), a mobile phone, a gaming platform, an entertainment device, a router computing node, a mesh or other network node, a wireless access point, some combination thereof, and so forth. As illustrated, device 802 includes one or more input/output (I/O) interfaces 804, at least one processor 806, and one or more media 808. Media 808 include processor-executable instructions 810.

In an example embodiment of device 802, I/O interfaces 804 may include (i) a network interface for monitoring and/or communicating across network 814, (ii) a display device interface for displaying information on a display screen, (iii) one or more human-device interfaces, and so forth. Examples of (i) network interfaces include a network card, a modem, one or more ports, a network communications stack, a radio, and so forth. Examples of (ii) display device interfaces include a graphics driver, a graphics card, a hardware or software driver for a screen or monitor, and so forth. Examples of (iii) human-device interfaces include those that communicate by wire or wirelessly to human-device interface equipment 812 (e.g., a keyboard, a remote, a mouse or other graphical pointing device, etc.).

Generally, processor 806 is capable of executing, performing, and/or otherwise effectuating processor-executable instructions, such as processor-executable instructions 810. Media 808 is comprised of one or more processor-accessible media. In other words, media 808 may include processor-executable instructions 810 that are executable by processor 806 to effectuate the performance of functions by device 802. Processor-executable instructions may be embodied as software, firmware, hardware, fixed logic circuitry, some combination thereof, and so forth.

Thus, realizations for supporting web interaction using web revisitation patterns may be described in the general context of processor-executable instructions. Generally, processor-executable instructions include routines, programs, applications, coding, modules, protocols, objects, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 806 may be implemented using any applicable processing-capable technology, and one may be realized as a general purpose processor (e.g., a central processing unit (CPU), a microprocessor, a controller, etc.), a graphics processing unit (GPU), a derivative thereof, and so forth. Media 808 may be any available media that is included as part of and/or accessible by device 802. It includes volatile and non-volatile media, removable and non-removable media, storage and transmission media (e.g., wireless or wired communication channels), hard-coded logic media, combinations thereof, and so forth. Media 808 is tangible media when it is embodied as a manufacture and/or as a composition of matter.

As specifically illustrated, media 808 comprises at least processor-executable instructions 810. Processor-executable instructions 810 may comprise, for example, web software 104 (of FIG. 1). Generally, processor-executable instructions 810, when executed by processor 806, enable device 802 to perform the various functions described herein. Such functions include, by way of example, those that are illustrated in the various flow diagrams and those pertaining to features illustrated in the block diagrams, as well as combinations thereof, and so forth.

The devices, acts, features, functions, methods, modules, data structures, techniques, components, etc. of FIGS. 1-8 are illustrated in diagrams that are divided into multiple blocks and other elements. However, the order, interconnections, interrelationships, layout, etc. in which FIGS. 1-8 are described and/or shown are not intended to be construed as a limitation, and any number of the blocks and/or other elements can be modified, combined, rearranged, augmented, omitted, etc. in any manner to implement one or more systems, methods, devices, media, apparatuses, arrangements, etc. for supporting web interaction using web revisitation patterns.

Although systems, methods, devices, media, apparatuses, arrangements, and other example embodiments have been described in language specific to structural, logical, algorithmic, and/or functional features, it is to be understood that the invention defined in the appended claims is not necessarily limited to the specific features or acts described above. Rather, the specific features and acts described above are disclosed as example forms of implementing the claimed invention.

What is claimed is:

1. One or more processor-accessible tangible media comprising processor-executable instructions for using web revisitation patterns to support web interaction, wherein the processor-executable instructions, when executed, direct a device to perform acts comprising:
collecting revisitation data, the revisitation data including two or more visit times for visits by at least one user to each web page of multiple web pages;
analyzing the revisitation data to produce at least one respective revisitation characterization that is associated with each respective web page of the multiple web pages, each respective revisitation characterization reflecting a revisitation pattern for the respective web page, and each revisitation characterization comprising a revisitation group category selected from multiple revisitation group categories; and
utilizing, at a web browser, the at least one revisitation characterization for each web page of the multiple web pages to support web interaction by:
organizing a browsing history for the multiple web pages responsive to the revisitation group category to which each web page of the multiple web pages is associated; and
displaying the browsing history as organized by the associated revisitation group category of each web page of the multiple web pages.

2. A method for using web revisitation patterns to support web interaction, the method comprising acts of:
collecting revisitation data, the revisitation data including two or more visit times for visits to a web page by one or more users;
analyzing the revisitation data to produce at least one revisitation characterization that reflects a revisitation pattern for the web page; and
utilizing the at least one revisitation characterization to support web interaction.

3. The method as recited in claim 2, wherein the act of collecting comprises:
collecting the revisitation data from at least one browser history, from at least one web or proxy server log, from at least one search engine log, from at least one browser plug-in, or from at least one survey response.

4. The method as recited in claim 2, wherein the at least one revisitation characterization comprises one or more aggregate revisitation statistics; and wherein the act of analyzing comprises:
determining for the web page a total number of revisiting users, an average frequency of revisitation, an average inter-visit time between two consecutive visits by each user, or at least one summary metric.

5. The method as recited in claim 2, wherein the at least one revisitation characterization comprises one or more revisitation curves, each revisitation curve derived from a timestamp series of interactions with the web page that represents how the one or more users revisit the web page.

6. The method as recited in claim 5, wherein the act of analyzing comprises:
constructing a revisitation curve for the web page using the revisitation data that is collected from the one or more users.

7. The method as recited in claim 2, wherein the act of utilizing comprises:
crawling the web responsive to the at least one revisitation characterization.

8. The method as recited in claim 2, wherein the act of utilizing comprises:
analyzing a web site responsive to the at least one revisitation characterization.

9. The method as recited in claim 2, wherein the act of analyzing comprises:
acquiring multiple visit times to the web page by the one or more users;
ascertaining multiple inter-visit times from the multiple visit times; and
assigning the multiple inter-visit times to bins to facilitate further analysis.

10. The method as recited in claim 2, wherein:
the act of analyzing comprises applying the revisitation data for the web page to a machine learning algorithm and producing a revisitation group category, the revisitation group category comprising an indication of a revisitation pattern; and
the act of utilizing comprises using the revisitation group category to support the web interaction.

11. The method as recited in claim 2, wherein the act of utilizing comprises:
presenting, by a web browser or another application, a browsing history responsive to the at least one revisitation characterization corresponding to the web page, the web page having been previously-visited by the web browser.

12. The method as recited in claim 11, wherein the at least one revisitation characterization comprises a revisitation group categorization; and wherein the act of presenting comprises:
organizing the browsing history of previously-visited web pages by revisitation group categories that are respectively associated with each of the previously-visited web pages; and
displaying the browsing history as organized by the associated respective revisitation group category of each previously-visited web page.

13. The method as recited in claim 2, wherein the act of utilizing comprises:
ranking, by a web browser or another application, recently-visited web pages by associated revisitation characterizations; and
presenting, by the web browser or the other application, an auto-complete drop-down menu having the recently-visited web pages based, at least in part, on the ranking by their associated revisitation characterizations.

14. The method as recited in claim 2, wherein the act of utilizing comprises:
determining, by a web browser or another application, a revisitation characterization of a web page corresponding to a particular uniform resource locator (URL); and
displaying, by the web browser or the other application, the particular URL in an emphasized format so as to indicate the determined revisitation characterization of the corresponding web page.

15. The method as recited in claim 2, wherein the act of utilizing comprises:
determining a number of web pages that are estimated to have a relatively high likelihood of being revisited by a user; and
preloading the number of web pages that are determined to have the relatively high likelihood of being revisited by the user.

16. The method as recited in claim 2, wherein the act of utilizing comprises:
performing, by a search engine, a web search responsive to the at least one revisitation characterization to produce a set of search results.

17. The method as recited in claim 16, wherein the act of performing comprises:
providing as one or more feature inputs to a ranker of the search engine at least one page revisitation characterization when learning a ranking function or conducting the web search.

18. The method as recited in claim 16, wherein the act of performing comprises:
determining revisitation characterizations respectively associated with multiple web pages corresponding to at least a portion of the set of search results; and
presenting the portion of the set of search results responsive to the revisitation characterizations respectively associated with the multiple web pages.

19. The method as recited in claim 16, wherein the act of performing comprises:
providing commercial content that is related to the set of search results responsive to revisitation characterizations that are associated with web pages contained in the set of search results.

20. A device for using web revisitation patterns to support web interaction, the device comprising:
a revisitation data collector to collect revisitation data, the revisitation data including two or more visit times for visits to a web page by one or more users;
a revisitation data characterizer to analyze the revisitation data to produce at least one revisitation characterization that reflects a revisitation pattern for the web page; and
a revisitation characterization utilizer to utilize the at least one revisitation characterization to support web interaction.
